(19) United States
(12) Patent Application Publication
(10) Pub. No.: US 2026/0067903 A1
(43) Pub. Date: Mar. 5, 2026

(54) METHODS, REPEATERS, INFRASTRUCTURE EQUIPMENT, AND SYSTEMS

(71) Applicant: Sony Group Corporation, Tokyo (JP)

(72) Inventors: Yassin Aden AWAD, Basingstoke (GB); Samuel Asangbeng ATUNGSIRI, Basingstoke (GB); Vivek SHARMA, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 19/106,636

(22) PCT Filed: Sep. 27, 2023
(86) PCT No.: PCT/EP2023/076754

§ 371 Date: Feb. 26, 2025

(30) Foreign Application Priority Data
Sep. 29, 2022 (EP) 22198824.9

(51) Int. Cl. H04W 72/25; H04B 7/0408; H04B 7/155

(52) U.S. Cl. CPC H04W 72/25; H04B 7/0408; H04B 7/15507

(57) ABSTRACT

A method of operating a repeater in a wireless communications network is provided. The repeater transmits and receives signals from infrastructure equipment and communication devices. The method includes receiving side control information (SCI) from each infrastructure equipment via a control link. Each SCI relates to a backhaul link between the infrastructure equipment and the repeater and is tied to specific time periods. The SCI provides backhaul beam information, including beam identifiers, transmission or reception durations, and beam types, for managing signal transmission and reception over the backhaul link during the associated time period.

### BACKGROUND

### Field of Disclosure

The present disclosure relates to methods for the more efficient utilisation of repeaters, for example network controlled repeaters, in wireless communications systems.

The present application claims the Paris Convention priority from European Patent Application number EP22198824.9, filed on 29 Sep. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current future wireless communications networks, for example those which may be referred to as 5G or new radio (NR) systems/new radio access technology (RAT) systems or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems, as well as future generation communications systems.

The increasing use of different types of network infrastructure equipment, such as base stations and relay nodes/repeater devices, and terminal devices associated with different traffic profiles, as well as the consideration of deployment strategies for such network infrastructure equipment in various and varying environments, together give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a repeater. The repeater is configured to transmit signals to and/or receive signals from one or more infrastructure equipment forming part of a wireless communications network and to transmit signals to and/or receive signals from one or more communications devices. The method comprises receiving from each of the one or more infrastructure equipment, via a control link between that infrastructure equipment and the repeater, one or more pieces of side control information, SCI. Here, each SCI is associated with a backhaul link between one of the infrastructure equipment and the repeater, and each SCI is also associated with one of a plurality of specified time periods during which that SCI is received. Each SCI indicates backhaul beam information for each of one or more backhaul beams to be used for the transmission and/or reception of signals over the backhaul link with which that SCI is associated and during the specified time period with which that SCI is associated. The backhaul beam information comprises one or more of an identifier of each of the one or more beams, an indication of a duration over which signals are to be transmitted or received via each of the one or more beams, and an indication of a type of each of the one or more beams.

Embodiments of the present technique, which, in addition to methods of operating repeaters, relate to methods of operating infrastructure equipment, to repeaters, to infrastructure equipment, to circuitry for infrastructure equipment and repeaters, to wireless communications systems, to computer programs, and to computer-readable storage mediums, can allow generally for the more efficient transmission and reception of data in wireless communications systems, and particularly for the more efficient transmission and reception of data in wireless communications systems in which repeaters are deployed.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates an example of beamforming performed by a gNB;

FIG. 5 illustrates an example of a Reconfigurable Intelligent Surface (RIS) which may be configured to operate in accordance with certain embodiments of the present disclosure;

FIG. 6 illustrates an example of a network-controlled repeater (NCR) which may be configured to operate in accordance with certain embodiments of the present disclosure;

FIG. 7 shows a schematic example of a single transmission and reception point (TRP) providing both a control link (C-link) and backhaul link (B-link) and an NCR which may be configured to operate in accordance with certain embodiments of the present disclosure;

FIG. 8 shows a schematic example of two TRPs each providing a C-link and a B-link for an NCR which may be configured to operate in accordance with certain embodiments of the present disclosure;

FIG. 9 shows a schematic example of a single TRP with two panels for each of a C-link and a B-link for an NCR which may be configured to operate in accordance with certain embodiments of the present disclosure;

FIG. 10 shows a part schematic, part message flow diagram representation of a wireless communications system comprising a repeater, an infrastructure equipment, and a communications device in accordance with at least some embodiments of the present technique;

FIG. 11 shows an example of the provision of a single piece of side control information (SCI) in a specified time period to a repeater in accordance with at least some embodiments of the present technique;

FIG. 12 shows an example of the provision of more than one SCI in a specified time period to a repeater in accordance with at least some embodiments of the present technique;

FIG. 13 shows an example of a shared C-link between multiple TRPs and a repeater in accordance with at least some embodiments of the present technique;

FIG. 14 shows an example of separate C-links for multiple TRPs with one C-link per TRP between the TRP and a repeater in accordance with at least some embodiments of the present technique; and

FIG. 15 shows an example of a repeater utilising sub-band full duplex (SBFD) sub-bands in accordance with at least some embodiments of the present technique.

### DETAILED DESCRIPTION OF THE EMBODIMENTS

### Long Term Evolution Advanced Radio Access Technology (4G)

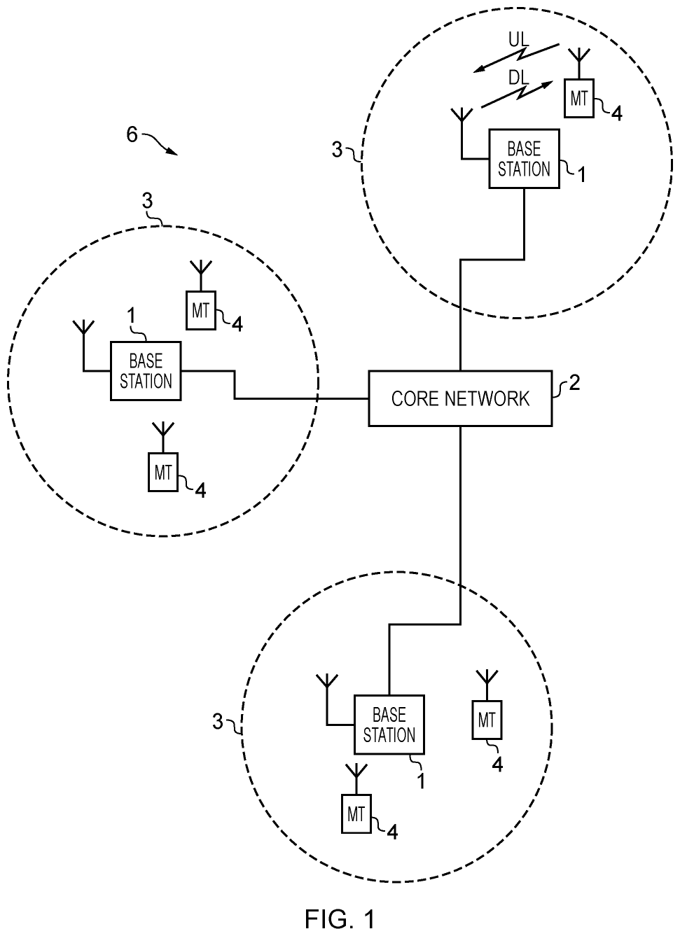

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

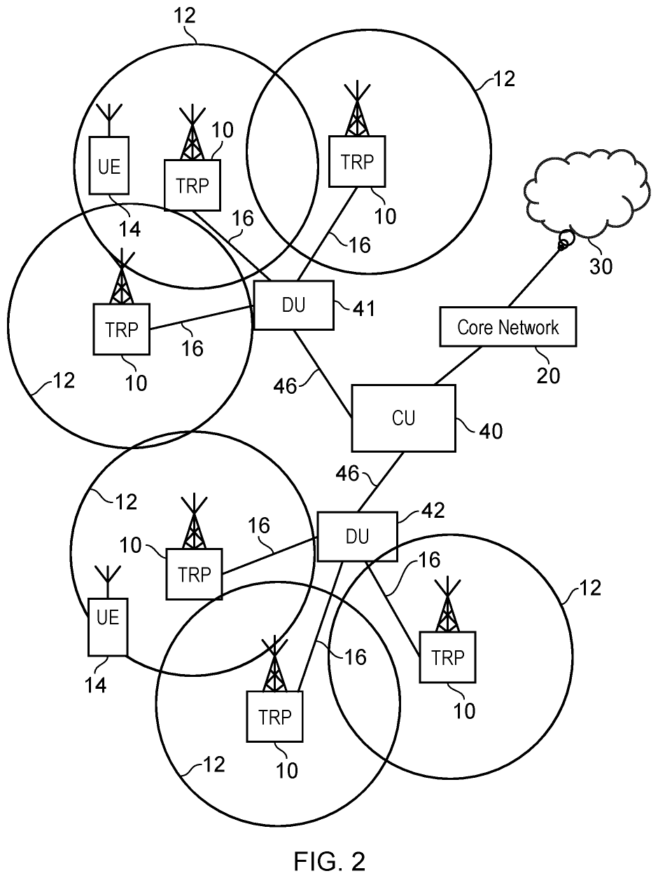

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

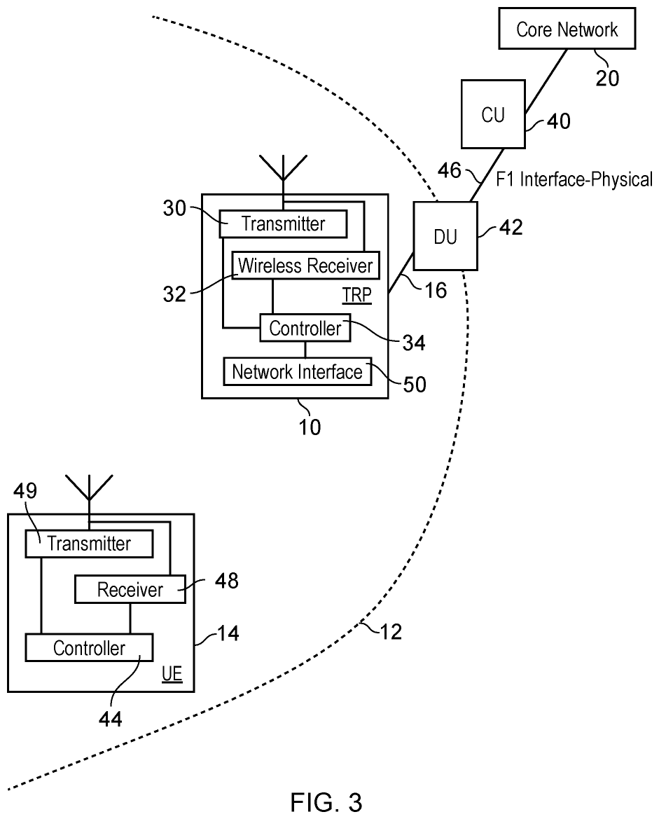

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc. configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Beamforming in Wireless Communications Systems

According to some radio access technologies, including NR radio access technologies as exemplified by FIGS. 2 and 3, a geographical cell may be formed (or, in other words, ‘generated’) by a plurality of directional beams. Each beam may be characterised by a variance in gain with respect to a direction from the antenna; a beam may be considered ‘wide’, where the gain is consistently relatively high over a broad range of directions, or ‘narrow’, where relatively high gain is only achieved over a narrow range of directions. A wider beam can be based on synchronisation signal blocks (SSBs) intended for example during initial access (in the RRC_IDLE and RRC_INACTIVE states) while a narrower beam can be formed from channel state information reference signals (CSI-RSs) intended for example for UE-specific beamforming in RRC_CONNECTED state. Depending on the direction of the communications device with respect to the infrastructure equipment, the gain of a particular beam may be sufficiently high (and the resulting coupling loss sufficiently low) to permit communications between the communications device and the infrastructure equipment via the beam. Beams may be formed for transmitting or receiving at the infrastructure equipment using phased antenna arrays, directional antennas, a combination of both, or other known techniques.

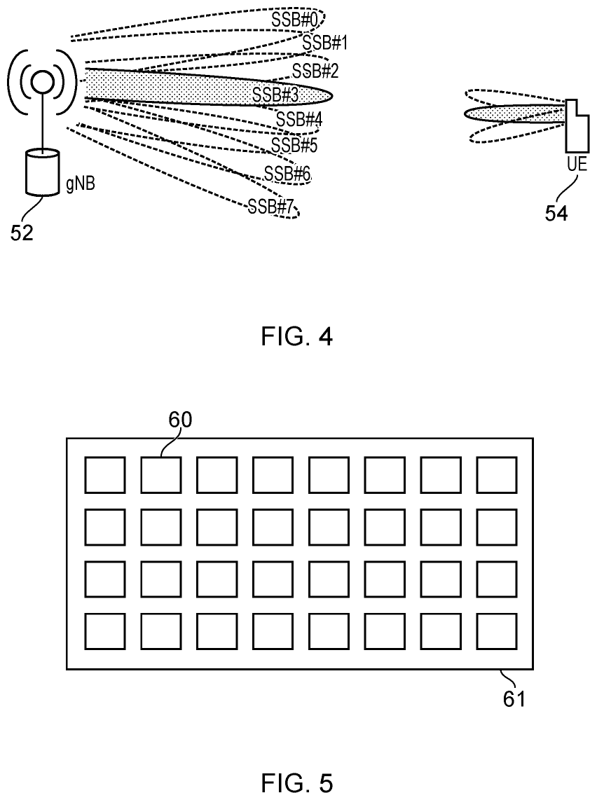

Typically, a gNB will perform beam-sweeping on different directions of a cell, as is shown in FIG. 4. Beam sweeping is where a gNB will activate one or more of a set of beams at a time (i.e. perform transmission or reception in one or more spatial directions at a time) and change these in turn to cover some or all of the set of beams according to predetermined directions and intervals. As can be seen in FIG. 4, the beam based on SSB #3 is activated by gNB 52 for transmitting/receiving signals to/from UE 54; this may have followed SSB #0, SSB #1 and SSB #2 being activated in turn, and may precede each of SSB #4, SSB #5, SSB #6 and SSB #7. Beam sweeping may be applied only to broadcast channels, and a dedicated beam may be applied to a UE in a known direction.

### Repeaters

While useful in a number of different scenarios, beamforming techniques such as those exemplified by FIG. 4 may be inefficient when a gNB is trying to transmit data to and receive data from a UE with which it does not have a clear direct line of sight, or which is on the cell edge or outside the coverage of the gNB, no matter the beam being considered. However, simply utilising a relay node for relaying signals between the gNB and UE in accordance with known (e.g. beamforming) techniques would then require successful reception and decoding of the received signal at that relay node, followed by amplification/encoding and subsequent transmission, resulting in increased latency as well as power consumption at that relay node. On the other hand, use of a repeater in such a scenario would be a lower cost solution which introduces less delay, since the repeater simply re-radiates incident signals without having to first decode them, allowing for the realisation of the advantages that beamforming would provide in terms of focussing signal power at a particular location to increase likelihood of successful reception of signals without the drawbacks relating to latency, cost, and power consumption associated with conventional relay nodes.

A repeater or RF repeater may be viewed as an element which receives a radio signal from a radio node (e.g. a base station or gNB, a relay, etc.), amplifies the signal and retransmits the signal without providing connectivity to the UE through an interface, such as a UE-base station interface (e.g. a Uu interface) or a UE-UE interface (e.g. a PC5 interface). As the repeater does not provide an interface to the terminal or UE and is operating as a transparent radio amplifier, amplifiers are sometimes referred to as radio frequency amplifiers, radio amplifiers or RF amplifiers. In the interest of conciseness, such amplifiers will be referred to “amplifiers”.

Some repeaters may also be referred to as smart repeaters or network-controlled repeaters (NCRs) when the repeaters are able, beyond the radio amplification function, to provide additional functions, such as processing control information from a base station and configuring the radio parameters for its transmission of amplified radio signals based on the received control information. For example and as discussed below, some network-controlled repeaters may be configured to receive and process side control information (SCI) from the network and for example take into account configurations such as semi-static and/or dynamic downlink/uplink configuration, adaptive transmitter/receiver spatial beamforming, ON-OFF status, etc. While a smart repeater may mimic some L1 functions of a base station (e.g. gNB), it will require an interface with the base station to receive the side control information.

The interface may be a Uu interface for example. The side control information may include information regarding radio resources to use, uplink/downlink information (in particular in Time Domain Duplexing (TDD) mode), beamforming information, operation mode, etc. Such smart or network-controlled repeaters differ from non-network-controlled repeaters, also referred to herein as autonomous repeaters, in that autonomous repeaters operate without receiving a configuration parameter from the network (e.g., from a base station or other type of radio node) which is adapted to the cell or radio node whose signals are to be repeated. In other words, an autonomous repeater uses a configuration which is independent of, or de-correlated from, the radio node whose signals it is repeated. Amplifiers, as discussed above, are examples of autonomous repeaters.

In the field of repeaters, those skilled in the art will be familiar with the concepts of active repeaters and passive repeaters. A passive repeater can be seen as a repeater which amplifies and/or re-radiates the radio signal and transmits the amplified signal without decoding the received signal or without any processing of the received signal besides the amplification. On the other hand, an active repeater can decode the radio signals and re-generate a new (and amplified) radio signal. Smart repeaters or network-controlled repeaters can be seen as a type of active repeaters which are configured through side control information from a base station. Autonomous repeaters tend to be mostly passive repeaters although some autonomous repeaters may be active repeaters, if for example they can operate as active repeaters using a pre-configuration and/or a configuration that can be used for a plurality or all of the radio nodes it can repeat.

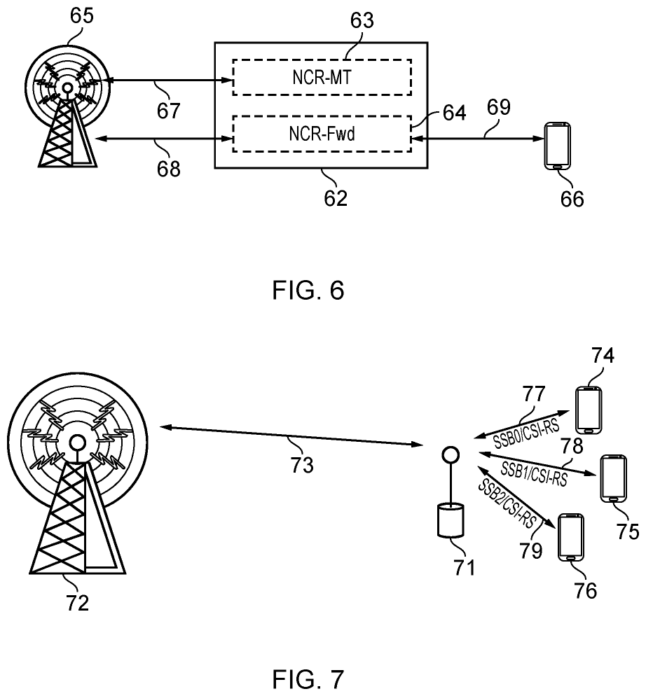

An example of a passive repeater is a Reconfigurable Intelligent Surface (RIS), which can be utilised to re-radiate a signal effectively using beamforming techniques, by changing the electric and magnetic properties of the RIS's surface. A RIS is typically a passive device, in the sense that it does not itself have a transceiver and cannot therefore decode any received signals or encode any signals for transmission—instead it simply, for example, amplifies and/or phase-shifts incident signals. In order to perform dynamic beamforming, and as shown in the example of FIG. 6, a RIS 61 may consist of a surface with N elements 60, where each element can receive a radio wave and reflects, or re-radiates, this radio wave with or without amplification and with a phase shift. The phase shift of each element can be independently configured, or the phase shifts applied to groups of elements can be configured jointly for each those groups of elements. By controlling the phase shifts of these elements, the reflected radio wave can be beamformed, thereby allowing the RIS to redirect the radio wave to a targeted location. Controlling the phase shifts can create a better received signal in both a certain direction and a certain distance from the RIS. Alternatively, the RIS can be configured to control the angle of reflection. Control of a RIS may be performed by a RIS controller, which may be connected to a gNB or network such that it can receive instruction from the gNB to direct beams incident at the RIS. The connection between the RIS controller and the gNB network can be, for example, an interface such as a cable (if the RIS 61 is nearby to the gNB), a microwave link, an IAB link, or a connection using the 5G air interface by implementing a UE receiver within the RIS controller (such that it can decode signalling received from the gNB). Whereas for a “normal” surface, the angle of reflection is equal to the angle of incidence, for a RIS, the angle of reflection can be controlled to be different to the angle of incidence. A RIS may also be known as, for example, a Large Intelligent Surface (LIS) or an Intelligent Reflecting Surface (IRS), and it can be used to enhance coverage in shadow areas, where the radio coverage is weak due to, for example, non-LOS (Line of Sight) between a gNB and a UE. Though the RIS shown in FIG. 6 is rectangular, those skilled in the art would appreciate that a RIS could be any size or shape, and RISs in accordance with embodiments of the present technique are not so limited.

While the RIS 61 of FIG. 5 is shown as comprising a number of RIS elements 60 which are independently configurable, a RIS—or indeed any kind of passive repeater—could instead be of a more analogue form, for example comprising a liquid or malleable material which could be configured so as to change the angle of reflection for example. A RIS or other type of passive repeater may alternatively comprise a plane mirror which is mounted so as that its angle is changeable, or may comprise a bendable or otherwise modifiable mirror, so that in either case incident radio waves get reflected in a different and configurable direction by changing the focal point of the mirror. It will be appreciated that, while having some similar characteristics, a mirror operating at radio frequencies would have a different construction to a mirror operating in the visible spectrum.

The network-controlled repeater (NCR) was a studied enhancement of the Rel-18 specifications, targeted at extending cell coverage. In addition to the amplify-and-forward operation of the RF signal, the NCR is defined as an RF repeater with the capability to receive and process side control information (SCI) from the network. The potential benefits of using NCRs could include the mitigation of unnecessary noise amplification, transmissions and receptions with better spatial directivity, and simplified network integration and deployment [2].

The outcome of the study [2] is captured in [3], some of the contents of which are reproduced in the following paragraphs with reference to FIG. 6, which is also reproduced from [3]. The NCR 62 is modelled as shown in FIG. 6, which includes the NCR-MT 63 and NCR-Fwd 64. The NCR-MT 63 is defined as a function entity to communicate with a gNB 65 via a control link (C-link) 67 to enable exchange of control information (e.g. side control information which is at least for the control of the NCR-Fwd 64). The C-link 67 is based on the NR Uu interface. The NCR-Fwd 64 is defined as a function entity to perform the amplify-and-forwarding of UL/DL RF signals between the gNB 65 and a UE 66 via the backhaul link (B-link) 68 and access link (A-link) 69. The behavior of the NCR-Fwd 64 is controlled according to the side control information (SCI) received from the gNB 65. Additionally, at least one of the NCR-MT's 63 carrier(s) should operate in the frequency band forwarded by the NCR-Fwd 64, while the operation of the NCR-MT 63 and NCR-Fwd 64 in the same frequency band was prioritised for the study.

It was concluded in [3] that the side control information for NCR has been studied with corresponding signalling (including its configuration), and the following are recommended to be specified as part of Rel-18 NCR:
Beam information as side control information;
ON-OFF information as side control information; and
UL-DL TDD configuration and NCR's behaviour over flexible symbols.

In more detail, beam information as side control information is captured in section 6.1 of [3], from which the following paragraphs are reproduced.

For the backhaul link and the C-link, both fixed beam and adaptive beam can be considered at the NCR, where the fixed beam refers to the case that a beam at the NCR, for both the C-link and the backhaul link, cannot be changed. Beam correspondence is assumed to apply for DL/UL of the backhaul link at the NCR-Fwd, as well as the DL/UL of the C-link at the NCR-MT. As a baseline, the same Transmission Configuration Information (TCI) states as the C-link are assumed for beams at the NCR-Fwd for the backhaul link if the NCR-MT's carrier(s) is operating within the frequency band forwarded by the NCR-Fwd. In the case that the adaptive beams are adopted for the C-link and the backhaul link, the indication and determination of the beams of the backhaul link can be achieved by either:
Option 1: The beam of the backhaul link is indicated by a new signalling. The new signalling may be dynamic signalling and/or semi-static signalling (e.g. RRC signalling/MAC CE) indicating a beam(s) from the set of beams of the C-link. This does not imply that the beam of backhaul link is always indicated by the new signalling; or
Option 2: The beam of the backhaul link is determined by a pre-defined rule, e.g. in slots/symbols with simultaneous DL receptions/UL transmissions in both the C-link and the backhaul link, the beam of the backhaul link is the same as the beam of the C-link. Otherwise, the beam of the backhaul link follows one of the beams of the C link. Those skilled in the art would of course appreciate that other predefined rules are not precluded.

At least for the access link, beam information is beneficial and recommended as the side control information for a network-controlled repeater to control the behaviour of the NCR for the access link. Regarding the access link beam indication, the beam of the access link for the NCR-Fwd is indicated by a beam index where both dynamic indications and semi-static indications, including semi-persistent indication, are considered. The time domain resource corresponding to an access link beam is explicitly determined based on the explicitly indicated time domain resources per beam indication. A single beam indication can indicate one or multiple beams. Different parameters may be indicated for semi-static or dynamic beam indications.

### Single and Multi-TRP/Multi-Panel

In Rel-15 NR, a UE supports the reception from and the transmission to a single point (i.e., single TRP), where beam sweeping is used at least for the initial access procedures (i.e. SSBs are beamformed in different directions at different times). Hence, in this case, in the context of the NCRs, we can assume that the C-link and backhaul link (B-link) may be based on single TRP as shown in the example of FIG. 7. As can be seen in FIG. 7, a single TRP (e.g. gNB) 72 provides, via a C-link and B-link for example illustrated by the arrow 73, control and data connections to a repeater (e.g. an NCR) 71. The repeater 71 may be configured to communicate with three (or indeed any number of) UEs 74, 75, 76 via at least three access beams (e.g. beam 77 to UE 74, which may have a beam index of 0, beam 78 to UE 75, which may have a beam index of 1, and beam 79 to UE 75, which may have a beam index of 2). Based on this, there will be a single B-link and a single C-link, but such links may be formed by dynamic (i.e. changeable) beams.

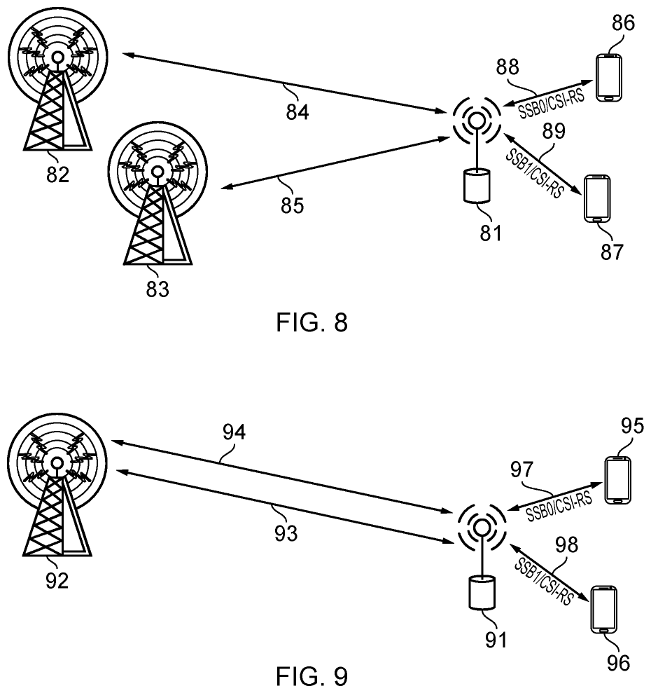

In Rel-16/17, Multiple Transmit/Receive Point Operation (Multi-TRP, or M-TRP) has been introduced, where a UE can have simultaneous connections and thus receive and transmit from/to two or more TRPs. The motivation for this is, at least partly, to increase the coverage and reliability of the transmissions, which is also essential for the coverage of the NCR's C-link and B-link. The relevant high-level description of the specification of multi-TRP is captured in section 6.12 of [4]. In this case, in the context of NCR, we can assume that a NCR can receive from and transmit to two or more TRPs, as shown in the example of FIG. 8. As can be seen in FIG. 8, two TRPs (e.g. gNBs) 82, 83 each independently provide, via a C-link and B-link for example illustrated by the arrows 84 and 85 for TRPs 82 and 83 respectively, control and data connections to a repeater (e.g. an NCR) 81. The repeater 81 may be configured to communicate with two (or indeed any number of) UEs 86, 87 via at least two access beams (e.g. beam 88 to UE 86 and beam 89 to UE 87).

In a similar scheme, an NCR may be configured to operate simultaneous DL multi-analog beam transmissions using multi-panel for a single user. In addition, an NCR may be configured to operate simultaneous UL multi-analog beam transmissions towards multi-panel reception to enhance coverage, reliability and throughput performance, as shown in the example of FIG. 9. As can be seen in FIG. 9, a single TRP (e.g. gNB) 92 provides multi-panel transmission and reception illustrated by the arrows 93 and 94 (which may for example each include a C-link and B-link or may each include a B-link and share a common C-link), to a repeater (e.g. an NCR) 91. The repeater 91 may be configured to communicate with two (or indeed any number of) UEs 95, 96 via at least two access beams (e.g. beam 97 to UE 95 and beam 98 to UE 96).

Based on the M-TRP scenario, there will be multiple B-links and possibly, one or more C-links. The NCR-Fwd may receive signals on the backhaul from the gNB/TRP, and then amplify and forward the same signals to the UEs on the access link. The NCR-Fwd may steer, reflect, or beamform the signals based on the beam index indicated by the side control information. As captured in [3], the side control information is carried on the control-link and received by the NCR-MT. However, it is not clear how the NCR-Fwd would know the duration of transmission on each beam, as it is possible for there to be one or more beams in a slot.

In addition, there are at least two types of beams: wide beams and narrow beams. The wide beams are usually formed by SSB signals whilst the narrow beams are formed by CSI-RS signals and other channels. As the NCR-Fwd is not capable of detecting or decoding the signals on the backhaul from the gNB, it is necessary for there to be a way to inform the NCR-Fwd about the type of the received beam index in order for the NCR-Fwd to perform the correct beamforming type. Furthermore, on the backhaul, there could be a single TRP or multiple TRPs as described above with respect to the examples of FIGS. 7 to 9. As such, there are at least two links received at the NCR; either from the same gNB or from multiple gNBs. However, the utilisation of the multiple B-links carrying data impacts the selection of one or more C-links carrying the side control information.

Therefore, a technical problem relating to NCRs, and indeed to all types of repeaters deployed in scenarios such as those described in the paragraphs above, is how the repeater (e.g. the NCR-Fwd entity of an NCR) can determine the duration of transmission on each beam and the type of each beam in both single-TRP and multi-TRP scenarios. Embodiments of the present disclosure seek to provide solutions to such a technical problem.

### Enhanced Control Link Resource Signalling for a Repeater

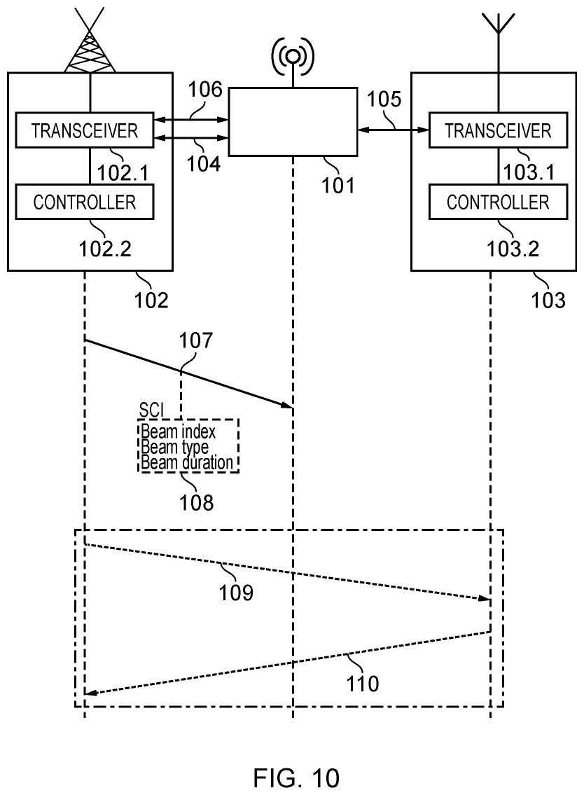

FIG. 10 shows a part schematic, part message flow diagram representation of a wireless communications system comprising a repeater 101, an infrastructure equipment 102 (as well as optionally one or more other infrastructure equipment), and a communications device 103 (as well as optionally one or more other communications devices) in accordance with at least some embodiments of the present technique. The infrastructure equipment 102 is configured to transmit signals to and/or receive signals from the communications device 103, where such signals may be transmitted and/or received via the repeater 101. Specifically, the infrastructure equipment 102 may be configured to transmit data to the repeater 101 via a backhaul link 104 between the infrastructure equipment 102 and the repeater 101, at which those signals are forwarded/re-radiated by the repeater 101 towards (and thus received by) the communications device 103 from the repeater 101 via an access link 105 between the communications device 103 and the repeater 101. Conversely, the infrastructure equipment 102 may be configured to receive data from the repeater 101 via the backhaul link 104, where those signals are forwarded/re-radiated by the repeater 101 towards (and thus received by) the infrastructure equipment 103 after having been received by the repeater 101 from the communications device 103 via the access link 105. The infrastructure equipment 102 may also be configured to transmit control information, such as side control information (SCI) to the repeater 101 via a control link 106 between the infrastructure equipment 102 and the repeater 101. The communications device 103 and the infrastructure equipment 102 each comprise a transceiver (or transceiver circuitry) 103.1, 102.1, and a controller (or controller circuitry) 103.2, 102.2. Each of the controllers 103.2, 102.2 may be, for example, a microprocessor, a CPU, or a dedicated chipset, etc.

As shown in the example of FIG. 10, the repeater 101 is configured to receive 107 from each of the one or more infrastructure equipment (such as infrastructure equipment 102), via the control link 106 between the infrastructure equipment 102 and the repeater 101, one or more pieces of side control information, SCI 108. Here, each SCI is associated with a backhaul link between one of the infrastructure equipment and the repeater 101 (e.g., backhaul link 104, though one or more of the SCIs 108 may relate to one or more other backhaul links between the repeater 101 and others of the infrastructure equipment). Each SCI 108 is also associated with one of a plurality of specified time periods during which that SCI 108 is received. Each SCI 108 indicates backhaul beam information for each of one or more backhaul beams to be used for the transmission and/or reception of signals over the backhaul link (e.g. backhaul link 104 and/or one or more of the other backhaul links) with which that SCI 108 is associated and during the specified time period with which that SCI 108 is associated. The backhaul beam information comprises one ore more of an identifier of each of the one or more beams and an indication of a duration over which signals are to be transmitted or received via each of the one or more beams (or, putting it another way, the duel time of the repeater (e.g. NCR) amplification of that particular beam), and may optionally also in some arrangements comprise an indication (either an explicit indication or an implicit indication) of a type of each of the one or more beams.

Optionally, in some arrangements of embodiments of the present technique, after the one or more pieces of SCI 108 have been received 107 by the repeater 101, the method may further comprise at least one of: receiving 109 downlink signals via the backhaul link 104 from the infrastructure equipment 102 (or indeed one or more other backhaul links from one or more other infrastructure equipment) using one or more backhaul beams for which backhaul beam information is indicated by one or more of the received pieces of SCI 108, and forwarding 109 the received downlink signals via the access link 105 to the communications device 103 (or indeed one or more other access links to one or more other communications devices) using one or more access beams, and receiving 110 uplink signals via the access link 105 from the communications device 103 (or indeed one or more other access links from one or more other communications devices) using one or more access beams, and forwarding 110 the received uplink signals via the backhaul link 104 to the infrastructure equipment 102 or indeed one or more other backhaul links to one or more other infrastructure equipment) using one or more backhaul beams for which backhaul beam information is indicated by one or more of the received pieces of SCI 108. Here, the access link(s) may have an association with the backhaul(links), and/or the access beam(s) may have an association with the backhaul beam(s).

Those skilled in the art would appreciate, in accordance with various arrangements of embodiments of the present techniques—some of which are described in greater detail in the following paragraphs—that the repeater 101 may be connected only to the single infrastructure equipment 102 via a single backhaul link in a single-TRP scenario, while in a multi-TRP scenario, the repeater 101 may be connected to a single infrastructure equipment via multiple backhaul links or via multiple infrastructure equipment via multiple backhaul links (e.g. one backhaul link per infrastructure equipment). In such scenarios, each backhaul link may be associated with a control link, or a single common control link 106 could be used from a single infrastructure equipment 102 in multiple-TRP scenarios with one or more infrastructure equipment connected to the repeater 101 via one or more backhaul links. One or more of the received pieces of SCI 108 may apply to each of the backhaul links (or indeed the only backhaul link 104 in some scenarios), and these may be received via the single, multiple, or common control link.

Those skilled in the art would further appreciate that, although embodiments of the present technique are described mostly from the point of view of NCRs, which include an NCR-MT and an NCR-Fwd, it is within the scope of the present disclosure and indeed of the dependent claims that such embodiments of the present technique may relate to any appropriate type of active or passive repeater, including but not limited to: NCRs (with any appropriate architecture), smart repeaters, autonomous repeaters such as amplifiers, and RISs.

Essentially, embodiments of the present technique propose that a repeater (e.g. the NCR-MT of an NCR) receives one or more pieces of side control information (SCIs) corresponding to one or more backhaul links, where each SCI contains one or more beam indexes/IDs in a slot/mini-slot period (or, more generally as referred to herein, a specified time period), and where each beam index or SCI comprises associated signalling of a beam duration (e.g. a time-domain resource allocation) and a beam type (e.g. wide or narrow).

### Beam Duration Signalling

In order for a repeater (e.g. the NCR-Fwd of a NCR) to know the duration of each beam on the backhaul-link, it is envisioned here that each beam index that is carried on the SCI must have a time duration within a slot/mini-slot period, or within some other specified time period or instance. This means that it is necessary in accordance with embodiments of the present technique to indicate the time domain resources which the indexed beam occupies. Based on this, three options can be considered for resource allocation signalling of each beam index:
Option 1. Start and end OFDM symbols in a slot period. In other words, the indication of the duration over which signals are to be transmitted or received via each of the one or more beams may comprise an indicated starting symbol in the specified time period and an indicated ending symbol in the specified time period. Those skilled in the art would appreciate that the overhead available for this signalling may be small and so can only signal a single contiguous resource in a slot period; i.e. there is no flexibility for the signalling of non-contiguous resources;
Option 2. Bit map of OFDM symbols in a slot period (1-bit indicates ON or OFF). In other words, the indication of the duration over which signals are to be transmitted or received via each of the one or more beams may comprise an indicated bitmap of all symbols in the specified time period. The overhead of this option is higher than that of option 1, but it has an advantage of allowing for the possibility of signalling multiple non-adjacent resources in a slot period associated with the same beam index (i.e. the beam index only needs to be signalled once); and
Option 3. Start OFDM symbol and length (i.e. in consecutive symbols) in a slot period. In other words, the indication of the duration over which signals are to be transmitted or received via each of the one or more beams may comprise an indicated starting symbol in the specified time period and an indicated length in symbols in the specified time period. Like option 1 above, those skilled in the art would appreciate here that only a single contiguous resource can be indicated here in a slot period for a particular beam index.

### Beam Type Signalling

As described above, there are at least two types of beams, which can be referred to informally as wide beams and narrow beams. The wide beams are usually formed by SSB signals whilst the narrow beams are shaped by CSI-RS signals. As such, in accordance with embodiments of the present disclosure, the term beam type can refer to at one or more of the following non-limiting alternatives: the indication of the type of each of the one or more beams may comprise an indicated width of that beam (e.g. wide or narrow, or a specific width in terms of degrees for example), the indication of the type of each of the one or more beams may comprise an indicated frequency band of that beam, or the indication of the type of each of the one or more beams may comprise an indication of a type of signal (e.g. SSB or CSI-RS) used to form that beam.

As the NCR-Fwd is not capable of detecting or decoding the signals on the backhaul from the gNB, instead simply receiving and forwarding such signals, there needs be a way to inform the NCR-Fwd about the type of the received beam for a specified beam index in order for the NCR-Fwd to utilise the correct beamforming type. There are at least two alternatives for informing the NCR about the beam type:
Alt-1. Semi-static signalling. The information relating to the beam type (e.g. wide or narrow) can be associated with the beam index in advance (semi-static). In other words, the indication of the type of each of the one or more beams in backhaul beam information may be implicitly indicated by the identifier of that beam indicated in the backhaul beam information. As such, when the NCR receives the beam index, it already knows which type of beam/reference signal (SSB or CSI-RS) is present. The semi-static signalling can be implemented via RRC or MAC CE, for example; or
Alt-2. Dynamic signalling. The information of beam type (e.g. wide or narrow) can be dynamically indicated in the SCI together with the beam index. In other words, the indication of the type of each of the one or more beams in backhaul beam information may be an explicit (and dynamic) indication carried by the SCI.

It would also be appreciated by those skilled in the art that narrow beams (and indeed, also wide beams) could also be defined by one of a number of granular values, where one value may be associated with a given beam index, for example 20 degrees 30 degrees or 45 degrees beamwidth (e.g. azimuth beamwidth). In other words, the indicated beamwidth may be indicated from one of a plurality of predefined beamwidths.

### Resource Allocation for Single-TRP Scenarios

For a single TRP, there is typically a single C-link as well as a single B-link, as shown in FIGS. 6 and 7. In a slot period or other specific time period, there could be one or more beams transmitted sequentially in time on the B-link. Consequently, in accordance with some arrangements of embodiments of the present technique, a single SCI can be scheduled in a slot period to carry the information of all beams transmitted sequentially in time on the B-link, such as beam indexes, and associated time-domain resource allocation (e.g. beam duration) and beam type for each beam index. On the other hand, in accordance with some other arrangements of embodiments of the present technique, more than one SCI can be scheduled in a slot period. Hence, there are a number of options for the signalling of SCI in accordance with arrangements of embodiments of the present disclosure, as described in more detail below.

Option 1. A single SCI is allowed in a slot period: In this option, a single SCI can be scheduled in a slot period to carry the information of all beams transmitted on the B-link. The SCI carries the information of one or more beam indexes/IDs corresponding to the backhaul-link, where each beam index has its associated signalling of time-domain resource allocation and beam type. In other words, within each of the specified time periods, all of the received pieces of SCI (where in the single-TRP scenario, the number of received pieces of SCI is here just one single SCI) may be received at the same time, and wherein each SCI associated with that specified time period (e.g. the single SCI in the single-TRP scenario) indicates the backhaul beam information for all of the one or more beams to be used for the transmission of signals over the backhaul link with which that SCI is associated and during that specified time period.

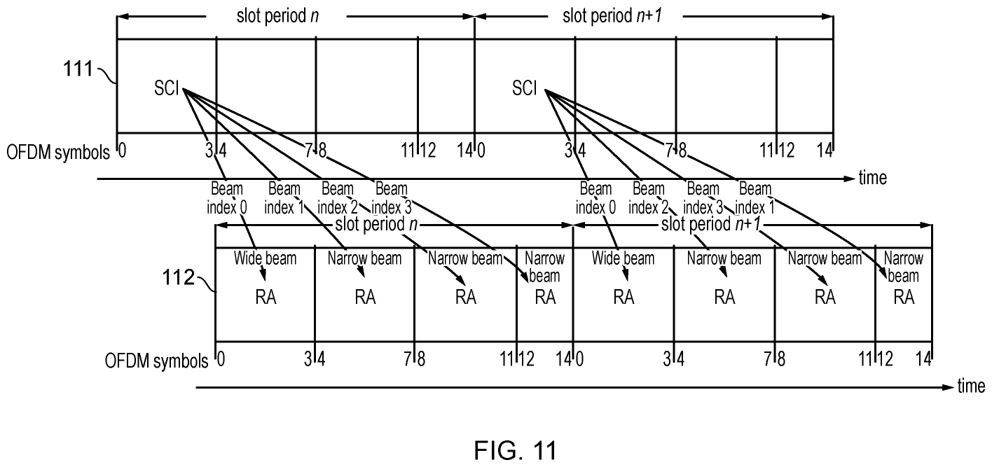

As shown in FIG. 11, the NCR-MT may receive an SCI on the C-link 111 in a slot period n which is position in time earlier than a corresponding slot period n on the B-link 112, so that the NCR-MT is able to decode the SCI before it receives anything via the B-link 112. The NCR-MT passes the information for each beam index to the NCR-Fwd which includes the beam index, associated time-domain resource allocation, and the beam type. Then, the NCR-Fwd amplifies and forwards the backhaul signals in the indicated/desired direction (for example, based on the beam index). As shown in FIG. 11, there are two slots in this example. In the first slot n, there is a single SCI transmitted on the C-link 111 which signals four beam indexes: 0, 1, 2 and 3. Beam index 0 is associated with a wider beam and a time-domain resource allocation (RA) starting from OFDM symbol number 0 and ending at symbol 3. Next, Beam index 1 has a beam type of narrow beam and an RA starting from symbol number 4 and ending at symbol 7. This then continues, as can been in FIG. 11, for the other beam indexes. Based on this information, the NCR-Fwd amplifies and forwards beam index 0 as a wider beam in the defined direction for beam index 0, employing time duration of starting symbol 0 and ending to 3. Next the NCR-Fwd amplifies and forwards beam index 1 as a narrow beam in the defined direction for index 1, with time duration from symbol 4 to 7, and so on for the other remaining beam indexes.

Option 2. More than one SCI is allowed in a slot period: Similarly to option 1, in option 2 the SCI carries the information of one or more beam indexes/IDs corresponding to the backhaul-link, where each beam index also has the associated signalling of time-domain resource allocation (e.g. beam duration) and beam type. However, the difference with option 2 as compared to option 1 is that one or more pieces of SCI are allowed to be scheduled at the same time or in different times/occasions in a slot period or some other specified time period/instance. In other words, within each of the specified time periods, there may be at least two occasions at which one or more of the received pieces of SCI associated with that specified time period are received (where in the single-TRP scenario, the number of received pieces of SCI at each of the at least two occasions here is just one single SCI), and wherein each SCI associated with that specified time period (e.g. the single SCI at each time occasion in the single-TRP scenario) indicates the backhaul beam information for only a subset of the one or more beams to be used for the transmission of signals over the backhaul link with which that SCI is associated and during that specified time period.

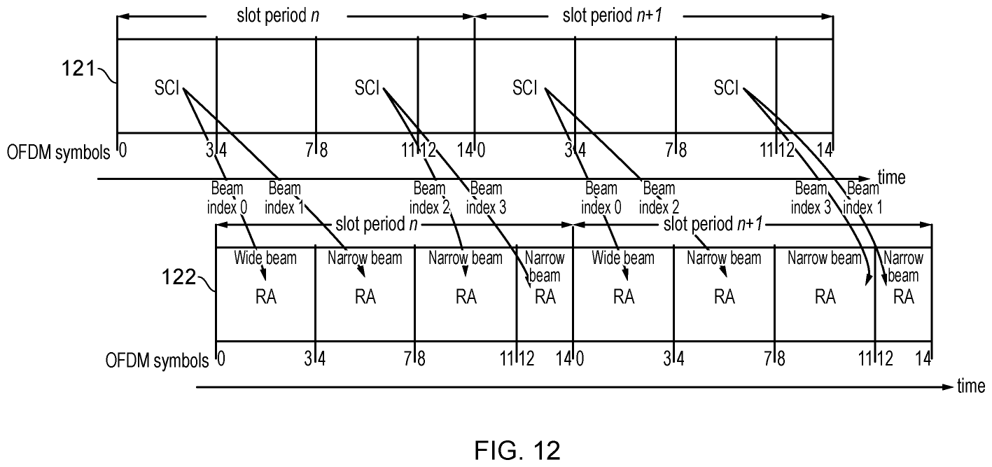

An example of this operation is shown in FIG. 12. The SCI scheduling period could be a single mini-slot period or multiple mini-slots, where a mini-slot is defined as a group of OFDM symbols less than the number of symbols in a slot. It would be appreciated by those skilled in the art that the 3GPP specifications define a mini-slot as being 2, 4 or 7 OFDM symbols, where each mini-slot has a PDCCH occasion (i.e. PDCCH resources for scheduling opportunities).

Comparing these two options above, option 1 does not provide as much scheduling flexibility as option 2. For example, if the gNB/TRP decides to schedule a different beam in the middle of a slot (for example, due to the arrival of high priority data in its buffers for transmission to another UE), the gNB/TRP cannot do this if operating in accordance with option 1, as the scheduling decision for that slot has already been made at the beginning of the slot. Conversely, option 2 as exemplified by FIG. 12 provides a better scheduling flexibility as the duration of each SCI scheduling period is shorter, and new pieces of SCI can be issued one after the other within slot period, for example in the middle of the slot, to schedule for the remaining symbols or to modify the earlier issued SCI in the slot period. As can be seen in example in FIG. 12, a first SCI may be transmitted by the gNB/TRP to the repeater between symbols 0 and 3 over the C-link 121 in slot period n, which signals two beam indexes 0 and 1 and their associated beam durations and types to be received by the repeater over the B-link 122. Then, later in the same slot period n between symbols 8 and 11, the gNB/TRP transmits a second SCI to the repeater over the C-link 121, which signals two further beam indexes 2 and 3 and their associated beam durations and types to be received by the repeater over the B-link 122.

In some arrangements of embodiments of the present technique, an advanced NCR can support option 2 while more basic and less complex NCRs may supports only option 1. For the gNB/TRP to know which option it is able to utilise in scheduling, the repeater (e.g. NCR) may provide its capability to the network in some manner, as is described in further detail below. This capability can be understood as having some relation to the PDCCH monitoring capabilities of a UE, where a UE is able to monitor a few occasions for PDCCHs/SCIs in a slot period.

### Resource Allocation for Multi-TRP Scenarios

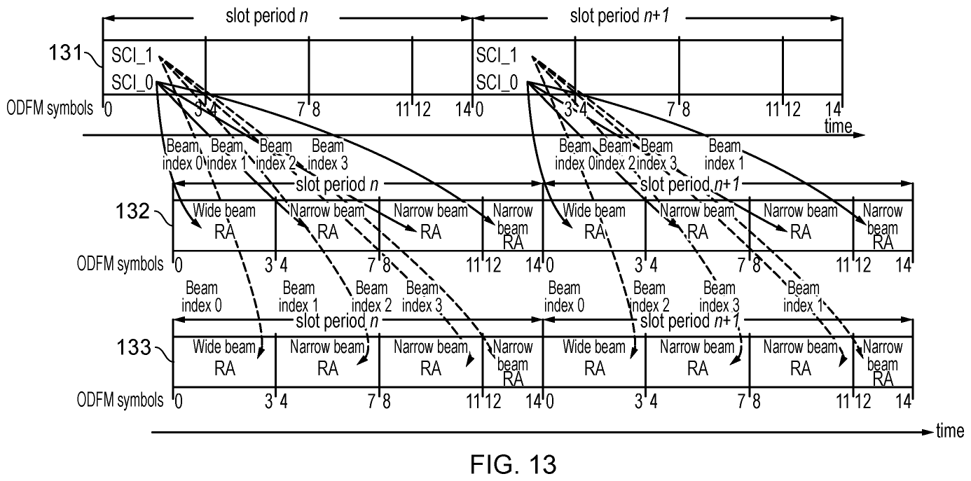

As mentioned above, embodiments of the present disclosure seek application with multi-TRP as well as with single-TRP. For a multi-TRP scenario (such as Coordinated Multi-Point (CoMP)), there are at least two links received at the NCR (on the same frequency band/BWP). How these links can be utilised depends on the configurations, which may be as follows:
Dynamic point selection: Assuming that the two (or more) TRPs are connected on the backhaul with ideal connections (i.e., there is no significant delay between them) and have a shared scheduler, it is possible to select one point at a time for dynamic scheduling of data. In this case, the C-link can be semi-statically configured or chosen from one of the TRPs, while the B-link is dynamically selected from one of the points at a time, where each point has (at least) one B-link with the repeater. Hence, there may be a shared C-link for both TRPs based on the chosen C-link, as shown in the example of FIG. 13. In other words, all of the received pieces of SCI may be received via a first (i.e. shared) control link from a first infrastructure equipment, and wherein one or more of the received pieces of SCI may be associated with a first backhaul link between the first infrastructure equipment and the repeater, and the other received pieces of SCI may be associated with a second backhaul link between a second infrastructure equipment and the repeater

As shown in FIG. 13, there are two pieces of SCI (SCI_0 and SCI_1) corresponding to TRP1 and TRP2 respectively. In this scenario, one SCI per TRP may be transmitted on the shared single C-link 131 in a slot or mini-slot period, which also indicates the selected TRP. The SCI carries the information of all beams transmitted on the B-link of the selected point (i.e. B-link 132 for TRP1 and B-link 132 for TRP2 as shown in FIG. 13), such as beam indexes, and associated time-domain resource allocation and beam type for each beam index;
SFN links: Assuming that the two TRPs are connected on the backhaul with an ideal connection (i.e., there is no significant delay between them) and have shared scheduler, it is possible to transmit identical data from both points for, for example, the purposes of coverage enhancement. The NCR will only see one B-link (based on Single Frame Network (SFN)), since the beams and data transmitted from both points are identical, and this is indicated to the repeater by the SCI. In this scenario, one SCI may be transmitted on the C-link in a slot or mini-slot period. The SCI may carry the information of all beams transmitted on the B-link of the selected point, such as beam indexes, and associated time-domain resource allocation and beam type for each beam index. In other words, all of the received pieces of SCI may be received via a first (shared) control link from a first infrastructure equipment, and wherein the received pieces of SCI are each associated with both of a first backhaul link between the first infrastructure equipment and the repeater and a second backhaul link between a second infrastructure equipment and the repeater, where the repeater considers the first backhaul link and the second backhaul link to be one single backhaul link due to the SCI indicating the same beam index, duration, and type for each of the first and second backhaul links, and the same data is received via each link.
Simultaneous B-links: In some scenarios, the NCR—should it have the capability to do so—can receive/transmit via two (or more) B-links simultaneously on the backhaul, in order to maximise throughput, where each B-link carries different beams and data. The two (or more) simultaneous B-links on the backhaul may employ separate antenna arrays/panels for each TRP, which also results in there being two simultaneous access links (for both DL and UL), for example for scheduling to two different UEs simultaneously based on analog beamforming.

In this scenario, the C-link can be semi-statically configured/chosen from one of the TRPs in a similar manner to that described above. This means that there will be a single shared C-link for both TRPs based on the chosen C-link as depicted earlier in the example of FIG. 13 as described above. The two SCI (SCI_0 and SCI_1) corresponding to TRP1 and TRP2 respectively may be transmitted simultaneously on the shared C-link. Hence, the NCR may receive two SCI on the shared C-link where each SCI carries the information of all beams transmitted on one B-link, such as beam indexes, and associated time-domain resource allocation and beam type for each beam index.

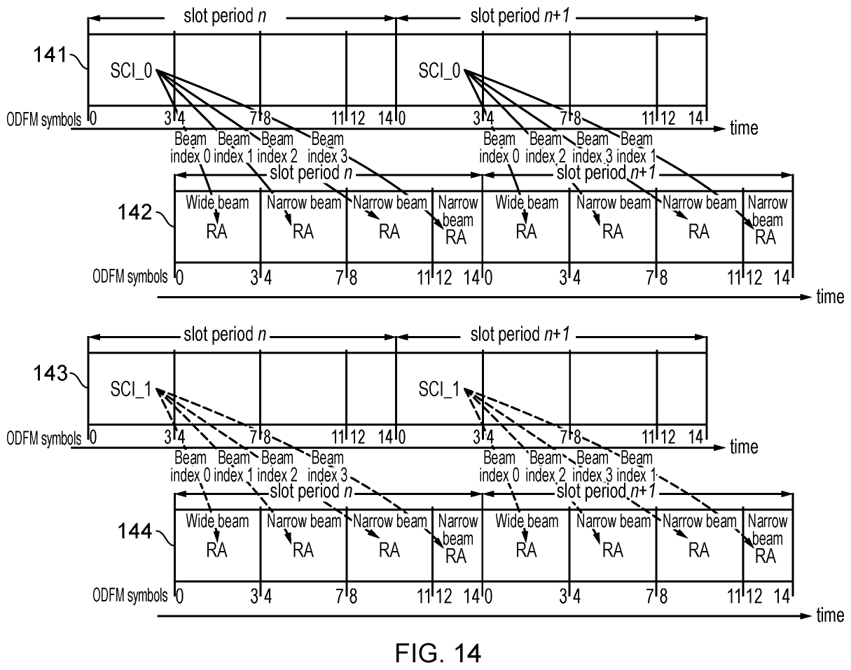

Conversely, in some arrangements of embodiments of the present technique, there could be two separate C-links, where each C-link may have its own B-link as well. In this case, there may be two SCI (SCI_0 and SCI_1) transmitted simultaneously from two separate TRPs, i.e., TRP1 and TRP2 respectively, as shown in the example of FIG. 14. In other words, one or more of the received pieces of SCI may be associated with a first backhaul link between the first infrastructure equipment and the repeater, and wherein the one or more of the received pieces of SCI may be received via a first control link between the first infrastructure equipment and the repeater, the first control link being associated with the first backhaul link. Generally speaking, all pieces of SCI relating to one backhaul link between the repeater and a gNB/TRP may be received from that gNB/TRP via a control link between the repeater and that gNB/TRP. That is, in other words, one or more of the received pieces of SCI may be associated with a second backhaul link between a second infrastructure equipment and the repeater, and wherein the one or more of the received pieces of SCI may be received via a second control link between the second infrastructure equipment and the repeater, the second control link being associated with the second backhaul link.

As shown in the example of FIG. 14, the NCR may receive one SCI from each C-link—i.e. C-link 141 from TRP1 and C-link 143 from TRP2—where each SCI carries the information of all beams transmitted on one B-link—i.e. B-link 142 from TRP1 and B-link 144 from TRP2—such as beam indexes, and associated time-domain resource allocation and beam type for each beam index.

In some arrangements of embodiments of the present technique, the same/identical time resource allocation (i.e. same duration) for TRP1 and TRP2 may be used, but the beam indexes may be different. Hence, a single SCI can be employed for both TRPs. In other words, each of the received pieces of SCI may indicate the same durations for the beams to be used for the transmission of signals over the first backhaul link as for the beams to be used for the transmission of signals over the second backhaul link, and wherein each of the received pieces of SCI may indicate different identifiers and types for the beams to be used for the transmission of signals over the first backhaul link than for the beams to be used for the transmission of signals over the second backhaul link.

In other arrangements of embodiments of the present technique, the same/identical time resource allocation, beam indexes and beam type may be used for TRP1 and TRP2 are used. Hence, again, a single SCI may be used for both TRPs. In other words, each of the received pieces of SCI may indicate the same backhaul beam information for the beams to be used for the transmission of signals over the first backhaul link as for the beams to be used for the transmission of signals over the second backhaul link.

It would be appreciate for those skilled in the art that for the multi-TRP scenario, it is still applicable in accordance with arrangements of embodiments of the present technique, as described above with respect to the single-TRP scenario and described with respect to FIGS. 11 and 12, that either a single SCI or more than one SCI is allowed for each TRP in a slot period. In other words, where a single SCI is allowed for each TRP in a slot (or other specified) period, within each of the specified time periods, all of the received pieces of SCI (where here there is one received piece of SCI per TRP) may be received at the same time, and wherein each SCI associated with that specified time period (e.g. each SCI per TRP) indicates the backhaul beam information for all of the one or more beams to be used for the transmission of signals over the backhaul link with which that SCI is associated and during that specified time period. Likewise, in order words, where more than one SCI is allowed for each TRP in a slot (or other specified) period, within each of the specified time periods, there may be at least two occasions at which one or more of the received pieces of SCI associated with that specified time period are received (where here, multiple SCIs—for each of the TRPs—are received at each of the two or more occasions), and wherein each SCI associated with that specified time period (e.g. one or more pieces of SCI per TRP at each occasion) indicates the backhaul beam information for only a subset of the one or more beams to be used for the transmission of signals over the backhaul link with which that SCI is associated and during that specified time period.

In some arrangements of embodiments of the present technique, the SCI may be carried by DCI, where each SCI corresponding to a TRP may for example have a unique identification such as different RNTIs or some bits may be included in the DCI to indicate the TRP index/ID. In other words, the one or more pieces of SCI may be received via dynamic signalling, where this dynamic signalling of the one or more pieces of SCI may comprise the one or more pieces of SCI being received via downlink control information, DCI.

In some arrangements of embodiments of the present technique, a number of SCI may be carried by PDSCH(s), where each SCI corresponding to a TRP may have a unique way of identifying its SCI location within PDSCH data, for example by that PDSCH data indicating an index in an ascending order of TRP indexes (0, 1, 2 etc.). In other words, the one or more pieces of SCI may be received via dynamic signalling, where this dynamic signalling of the one or more pieces of SCI may comprise the one or more pieces of SCI being received via one or more downlink data channels. Those skilled in the art would appreciate that DCI and PDSCH signalling are only examples of such dynamic signalling, and thus that other forms of dynamic signalling are within the scope of the present disclosure.

In some arrangements of embodiments of the present technique, the SCI may be configured semi-statically by higher layers, where fixed beams are occurring periodically in time. That is, the one or more pieces of SCI carrying the resource allocation of each beam index (or some of the beams such as only wide beams) may be received via semi-static signalling by the receiver. The signalling could be implemented via RRC, MAC CE, or the like. These fixed beams could be used to carry broadcast signals such as SSB, CORESET #0, SIBx, Paging, RACH occasions for Msg1 transmission, etc.

In some arrangements of embodiments of the present technique, the SCI may be configured via signalling which depends on the type of beam. In other words, a type of signalling via which each of the one or more pieces of SCI are received may depend on the type of the one or more beams to be used for the transmission and/or reception of signals over the backhaul link with which that SCI is associated and during the specified time period with which that SCI is associated, and wherein the type of signalling is one of semi-static signalling, static signalling, and dynamic signalling. Here, for example, the SCI may be carried via dynamic signalling for narrow beams and the SCI may be carried via static or semi-static signalling for wide beams.

In some arrangements of embodiments of the present technique, if no SCI carrying beam indexes is detected on the C-link, the NCR may assume the backhaul link (which corresponds to that C-link) is OFF and hence the access link may also be OFF in that time duration; i.e. it is implicit that there is no transmission during that time duration. In other words, the repeater may be configured to detect that, for one or more of the plurality of specified time periods, no pieces of SCI associated with one or more backhaul links are received via the control link, and to determine, based on detecting that no pieces of SCI associated with the one or more backhaul links are received via the control link for one or more of the plurality of specified time periods, that no signals are to be transmitted or received over the one or more backhaul links during the one or more of the plurality of specified time periods. Here, the repeater may further be configured to determine, based on determining that no signals are to be transmitted or received over the one or more backhaul links during the one or more of the plurality of specified time periods, that no signals are to be transmitted over one or more access links between the repeater and the one or more communications devices during the one or more of the plurality of specified time periods, wherein the one or more access links are associated with the one or more backhaul links.

In some arrangements of embodiments of the present technique, as described above, the repeater (e.g. NCR) may provide some indication of its capability to the network, for example if it is capable of receiving/transmitting two B-links simultaneously on the backhaul as well as access links (for both DL and UL)—i.e. capable of multi-TRP operation. That is, the repeater may be configured to transmit, one of the infrastructure equipment via a backhaul link between that infrastructure equipment and the repeater, an indication of a capability of the repeater.

As described above, this indication of the capability of the repeater may comprise an indication of whether (or not) the repeater is able to transmit signals to and/or receive signals from a first infrastructure equipment via a first backhaul link and simultaneously transmit signals to and/or receive signals from a second infrastructure equipment via a second backhaul link—i.e. whether it is capable of multi-TRP operation as well as single-TRP operation or whether it is only capable of single-TRP operation. Here, as would be understood by those skilled in the art, this can equally apply to the support of the repeater for connection to a single or multiple communications devices via access link(s), either in combination with or separately to its capability of connection to a single TRP or multiple TRPs simultaneously.

Alternatively, or in addition, this indication of the capability of the repeater may comprise an indication of whether the repeater is an active repeater (e.g. an NCR, a smart repeater, an autonomous repeater) or a passive repeater (e.g. an autonomous repeater such as an amplifier, or a RIS). Here, where the repeater is a passive repeater, it may for example be connected to some kind of repeater controller which is actually connected to the gNBs/TRPs via the C-link and receives the SCI, and controls the (passive) repeater on the basis of that. Hence the (passive) repeater may only be connected to the gNBs/TRPs via B-links, and to communications devices via access links.

Alternatively, or in addition, this indication of the capability of the repeater may comprise an indication of a range over which the repeater is able to transmit and/or receive signals—e.g. the indication of the capability of the repeater may indicate a maximum amplification gain or maximum power of the repeater.

Alternatively, or in addition, this indication of the capability of the repeater may comprise an indication of whether the repeater supports option 2 as described above (i.e., that it can support more than one SCI per slot/specified time period) or whether the repeater supports only option 1 as described above (i.e. that it can support only a single SCI per slot/specified time period). In other words, the indication of the capability of the repeater may comprise an indication of whether the repeater is able, within each of the specified time periods, to receive SCI at only one occasion or at more than one occasion.

Alternatively, or in addition, this indication of the capability of the repeater may comprise the repeater sharing its beam configuration with the gNB/TRP. In other words, the indication of the capability of the repeater may comprise an indication of a beam configuration of the repeater on one or more backhaul links and/or one or more access links. Here, this beam configuration may refer to a number of beams or antenna panels for example (e.g. for wide and/or narrow beams) on the backhaul/access links.

In accordance with arrangements of embodiments of the present technique, the indication of the capability of the receiver can be transmitted by the receiver to the network during initial access to a gNB/TRP, or on a periodic basis, or in response to a request from the network.

In some arrangements of embodiments of the present technique, the C-link and B-link can either have corresponding BWPs and corresponding SCSs. However, in other arrangements of embodiments of the present technique, the C-link and B-link may have different BWPs with different subcarrier spacings (SCS). In other words, signals may be transmitted and/or received by the repeater within a first bandwidth part, BWP, and with a first subcarrier spacing, SCS, via the control link and within a second BWP and with a second SCS via a backhaul link that is associated with the control link, wherein the first BWP may be different to the second BWP and the first SCS may be different to the second SCS. Those skilled in the art would appreciate that other parameters to BWP and SCS may be the same or different between a C-link and its associated B-link(s), or only one of BWP and SCS may differ between them (for example, different BWPs may use the same SCS). In other words, signals may be transmitted and/or received by the repeater within a first bandwidth part, BWP, and with a first subcarrier spacing, SCS, via the control link and within a second BWP and with the first SCS via a backhaul link that is associated with the control link, wherein the first BWP may be different to the second BWP

For example, a C-link may have a BWP having a 15 KHz subcarrier spacing and a B-link may have a BWP having a 60 KHz subcarrier spacing, or in another example, the C-link may have a BWP with a 60 KHz subcarrier spacing while the B-link has a different BWP but also having a 60 KHz subcarrier spacing. In this case, the B-link and access link may have the same SCS (and BWP). In other words, signals may be transmitted to and/or received from one of the communications devices by the repeater via an access link between the repeater and that communications device within the first BWP and with the first SCS. The impact of the C-link having a different SCS to the B-link is that the NCR-MT must be configured/signalled that the B-link has different SCS in the SCI.

In some arrangements of embodiments of the present technique, an NCR may support Subband Full Duplex (SBFD), which as would be understood by those skilled in the art, the TDD system bandwidth is divided into two or more non-overlapping sub-bands which are used for either UL transmissions, DL transmission, or in some cases a combination of UL and DL transmissions depending on the symbol index. In other words, signals may be transmitted and/or received by the repeater in one or more of a plurality of frequency sets (e.g. sub-bands), each of the plurality of frequency sets being either only for the transmission or reception of downlink signals or only for the transmission or reception of uplink signals.

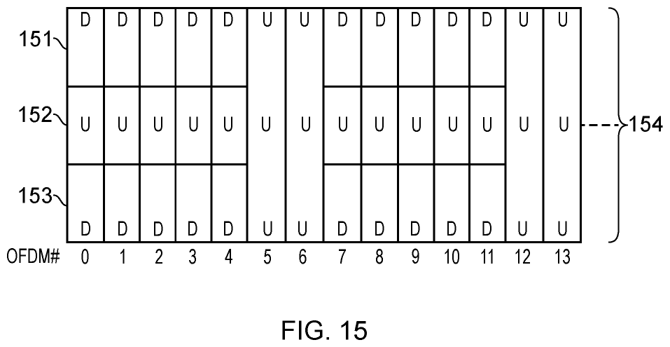

An example is shown in FIG. 15, where there are three non-overlapping sub-bands in system bandwidth 154 where a first sub-band 151 and a third sub-band 153 may be used for DL transmissions, and a second sub-band 152 may be used for UL transmission, as shown in the example of FIG. 15. Hence, in accordance with such arrangements of embodiments of the present technique, it is envisioned that the NCR may be capable of amplifying and forwarding the backhaul signals located on the DL sub-bands based on the indicated/desired direction of the access link, i.e. the NCR does not forward the other sub-bands. In other words, the downlink signals may be received by the repeater from the infrastructure equipment within a first of the frequency sets which is only for the transmission or reception of downlink signals, and the downlink signals may subsequently be (amplified and) forwarded by the repeater to the communications device using the first frequency set. Correspondingly, the NCR may be capable of amplifying and forwarding the UL signals located on the UL sub-bands to the gNB/TRP. In other words, the uplink signals may be received by the repeater from the communications device within a second of the frequency sets which is only for the transmission or reception of uplink signals, and the uplink signals may subsequently be (amplified and) forwarded by the repeater to the infrastructure equipment using the second frequency set.

In some arrangements of embodiments of the present technique, an NCR may support one-to-one mapping (1:1) between the backhaul beam type and access beam type. In other words, a single access beam may be mapped to a single backhaul beam. In other arrangements of embodiments of the present technique, an NCR may support many-to-one mapping (N:1) between the backhaul beams and access beam. In other words, a single access beam is mapped to a plurality of the backhaul beams. In this case, all different backhaul beam types may be mapped to one wider beam type where all UEs can receive via the access link. In some further arrangements of embodiments of the present technique, an NCR may support one-to-many mapping (1:N) between the backhaul beam and access beam. In other words, a plurality of the access beams are mapped to a single backhaul beam. In this case, a backhaul beam type may be mapped to several narrow beams on the access link (for example for the case there are separate antenna arrays/panels at the NCR access link). In yet further arrangements of embodiments of the present technique, an NCR may support many-to-many mapping (N:N) between the backhaul beam and access beam. In other words, each of a plurality of the backhaul beams may each be mapped to one of a plurality of the access beams. In this case, for each backhaul beam, there is a corresponding access beam. Here, in accordance with these arrangements of embodiments of the present technique, such access beam to backhaul beam mapping can be changed, e.g. in a semi-static manner—though of course only if the NCR/repeater supports 1:N, N:1, or N:N mapping, where the W beams in either case can be changed to M beams (by adding, removing, or replacing any one or more of the N beams).

Generally, in accordance with the arrangements of embodiments of the present technique as described above, particularly in view of the examples of FIGS. 11 to 15, the discussion concentrated on DL beams on the backhaul and access links. However, it would be understood by those skilled in the art that arrangements focussing on how to inform a repeater (e.g. an NCR) as to which beams it needs to receive from the access link and then amplify and forward to the gNB needs to be addressed as well. Such arrangements of embodiments of the present technique are fully within the scope of the present disclosure as defined by the claims, and in accordance with the example of FIG. 10 as described above. Some such arrangements are described in further detail below.

Accordingly, it is envisioned that UL slots for transmissions from the NCR to the gNB on the backhaul link are scheduled by the gNB. In this case, the NCR-MT may receive an UL-SCI from the gNB corresponding to each backhaul UL slot or mini-slot or other appropriate specified time period that informs the NCR-Fwd which uplink beams (beam index, RA and beam type) to amplify and forward to gNB. This is in contrast to such SCI as described above in relation to the signalling of DL transmission, which may be referred to as DL-SCI. The reason for the signalling of the UL-SCI from the gNB to the repeater even though the signals are transmitted from the UE via the repeater to the gNB/TRP is that it is only the gNB that knows which UEs are currently scheduled to transmit on the UL resources on the access link, as the NCR cannot decode scheduling DCIs intended for the UEs for UL scheduling. Hence, when the gNB schedules the UEs in the access link for UL transmission, the gNB also schedules, through the NCR-MT with the same scheduling information, the NCR-Fwd to amplify and forward signals from certain direction(s) to the gNB. The UL-SCI may indicate to the NCR-MT exactly what direction(s) to forward from, and for how long during the scheduled UL slot or mini-slot.

That is, in accordance with at least some arrangements of embodiments of the present disclosure, the one or more of the received pieces of SCI which indicate the backhaul beam information for receiving the downlink signals via the backhaul link from the infrastructure equipment may be downlink side control information, DL-SCI, and wherein the one or more of the received pieces of SCI which indicate the backhaul beam information for forwarding the uplink signals via the backhaul link to the infrastructure equipment may be uplink side control information, UL-SCI.

In some arrangements of embodiments of the present technique, separate DL-SCI and UL-SCI may be received at the NCR-MT. In other words, DL-SCI and UL-SCI may be received by the repeater separately each as one or more of the received pieces of SCI

In some arrangements of embodiments of the present technique, the DL-SCI and UL-SCI may be combined into one SCI to be received at the NCR-MT. In other words, one or more of the received pieces of SCI may comprise both of DL-SCI and UL-SCI.

In some arrangements of embodiments of the present technique, the UL-SCI is configured semi-statically by higher layers where fixed beams are occurring periodically in time, i.e. the resource allocation of each beam index (or some of the beams such as only wide beams) is semi-statically informed to the NCR. The signalling could be via RRC, MAC CE. These fixed beams could be used to carry the beam index, beam type and RACH for Msg1 transmission.

In some arrangements of embodiments of the present technique, there may be no UL scheduling from the TRP/gNB, but for each backhaul UL slot, the NCR-Fwd in the uplink may receive all possible beams that exist on the access link, and then amplify and forward these beams to the gNB. In other words, the repeater may be configured to receive uplink signals via the access link from the communications device using all of one or more possible access beams, and to forward the received uplink signals via the backhaul link to the infrastructure equipment using one or more backhaul beams which correspond to the one or more access beams used to receive the uplink signals from the communications device. The existence of UL beams can be derived from DL beams (i.e., beam indexes carried by SCI or signalled/configured by higher layers), because—as would be understood by those skilled in the art—there is beam correspondence between DL beams and UL beams in NR.

Those skilled in the art would appreciate that method described herein may be adapted in accordance with embodiments of the present technique without departing from the scope of the claims. For example, other intermediate steps may be included in any described methods, or the described steps may be performed in any logical order. Though embodiments of the present technique have been described largely by way of the example communications system shown in FIG. 10, and described with respect to the operation examples defined by FIGS. 11 to 15, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a repeater configured to transmit signals to and/or receive signals from one or more infrastructure equipment forming part of a wireless communications network and to transmit signals to and/or receive signals from one or more communications devices, the method comprising
   receiving from each of the one or more infrastructure equipment, via a control link between that infrastructure equipment and the repeater, one or more pieces of side control information, SCI, wherein each SCI is associated with a backhaul link between one of the infrastructure equipment and the repeater, and wherein each SCI is associated with one of a plurality of specified time periods during which that SCI is received, and
   wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
      an identifier of each of the one or more beams,
      an indication of a duration over which signals are to be transmitted or received via each of the one or more beams, and
      an indication of a type of each of the one or more beams.
Paragraph 2. A method according to Paragraph 1, wherein the indication of the duration over which signals are to be transmitted or received via each of the one or more beams comprises an indicated starting symbol in the specified time period and an indicated ending symbol in the specified time period.
Paragraph 3. A method according to Paragraph 1 or Paragraph 2, wherein the indication of the duration over which signals are to be transmitted or received via each of the one or more beams comprises an indicated starting symbol in the specified time period and an indicated length in symbols in the specified time period.
Paragraph 4. A method according to any of Paragraphs 1 to 3, wherein the indication of the duration over which signals are to be transmitted or received via each of the one or more beams comprises an indicated bitmap of all symbols in the specified time period.
Paragraph 5. A method according to any of Paragraphs 1 to 4, wherein the indication of the type of each of the one or more beams comprises an indicated frequency band of that beam.
Paragraph 6. A method according to any of Paragraphs 1 to 5, wherein the indication of the type of each of the one or more beams comprises an indicated beamwidth of that beam.
Paragraph 7. A method according to Paragraph 6, wherein the indicated beamwidth is indicated from one of a plurality of predefined beamwidths.
Paragraph 8. A method according to any of Paragraphs 1 to 7, wherein the indication of the type of each of the one or more beams comprises an indication of a type of signal used to form that beam.
Paragraph 9. A method according to any of Paragraphs 1 to 8, wherein the indication of the type of each of the one or more beams in backhaul beam information is an explicit indication.
Paragraph 10. A method according to any of Paragraphs 1 to 9, wherein the indication of the type of each of the one or more beams in backhaul beam information is implicitly indicated by the identifier of that beam indicated in the backhaul beam information.
Paragraph 11. A method according to any of Paragraphs 1 to 10, wherein, within each of the specified time periods, there are at least two occasions at which one or more of the received pieces of SCI associated with that specified time period are received, and wherein each SCI associated with that specified time period indicates the backhaul beam information for only a subset of the one or more beams to be used for the transmission of signals over the backhaul link with which that SCI is associated and during that specified time period.
Paragraph 12. A method according to any of Paragraphs 1 to 11, wherein, within each of the specified time periods, all of the received pieces of SCI are received at the same time, and wherein each SCI associated with that specified time period indicates the backhaul beam information for all of the one or more beams to be used for the transmission of signals over the backhaul link with which that SCI is associated and during that specified time period.
Paragraph 13. A method according to any of Paragraphs 1 to 12, wherein all of the received pieces of SCI are received via a first control link from a first infrastructure equipment, and wherein one or more of the received pieces of SCI are associated with a first backhaul link between the first infrastructure equipment and the repeater, and the other received pieces of SCI are associated with a second backhaul link between a second infrastructure equipment and the repeater.
Paragraph 14. A method according to any of Paragraphs 1 to 13, wherein all of the received pieces of SCI are received via a first control link from a first infrastructure equipment, and wherein the received pieces of SCI are each associated with both of a first backhaul link between the first infrastructure equipment and the repeater and a second backhaul link between a second infrastructure equipment and the repeater.
Paragraph 15. A method according to Paragraph 14, wherein each of the received pieces of SCI indicates the same durations for the beams to be used for the transmission of signals over the first backhaul link as for the beams to be used for the transmission of signals over the second backhaul link, and wherein each of the received pieces of SCI indicates different identifiers and types for the beams to be used for the transmission of signals over the first backhaul link than for the beams to be used for the transmission of signals over the second backhaul link.
Paragraph 16. A method according to Paragraph 14 or Paragraph 15, wherein each of the received pieces of SCI indicates the same backhaul beam information for the beams to be used for the transmission of signals over the first backhaul link as for the beams to be used for the transmission of signals over the second backhaul link.
Paragraph 17. A method according to any of Paragraphs 1 to 16, wherein one or more of the received pieces of SCI are associated with a first backhaul link between the first infrastructure equipment and the repeater, and wherein the one or more of the received pieces of SCI are received via a first control link between the first infrastructure equipment and the repeater, the first control link being associated with the first backhaul link.
Paragraph 18. A method according to any of Paragraphs 1 to 17, wherein the one or more pieces of SCI are received via dynamic signalling.
Paragraph 19. A method according to Paragraph 18, wherein the dynamic signalling of the one or more pieces of SCI comprises the one or more pieces of SCI being received via downlink control information, DCI.
Paragraph 20. A method according to Paragraph 18 or Paragraph 19, wherein the dynamic signalling of the one or more pieces of SCI comprises the one or more pieces of SCI being received via one or more downlink data channels.
Paragraph 21. A method according to any of Paragraphs 1 to 20, wherein the one or more pieces of SCI are received via semi-static signalling.
Paragraph 22. A method according to any of Paragraphs 1 to 21, wherein a type of signalling via which each of the one or more pieces of SCI are received depends on the type of the one or more beams to be used for the transmission and/or reception of signals over the backhaul link with which that SCI is associated and during the specified time period with which that SCI is associated, and wherein the type of signalling is one of semi-static signalling, static signalling, and dynamic signalling.
Paragraph 23. A method according to any of Paragraphs 1 to 22, comprising
   detecting that, for one or more of the plurality of specified time periods, no pieces of SCI associated with one or more backhaul links are received via the control link, and
   determining, based on detecting that no pieces of SCI associated with the one or more backhaul links are received via the control link for one or more of the plurality of specified time periods, that no signals are to be transmitted or received over the one or more backhaul links during the one or more of the plurality of specified time periods.
Paragraph 24. A method according to Paragraph 23, comprising
   determining, based on determining that no signals are to be transmitted or received over the one or more backhaul links during the one or more of the plurality of specified time periods, that no signals are to be transmitted over one or more access links between the repeater and the one or more communications devices during the one or more of the plurality of specified time periods, wherein the one or more access links are associated with the one or more backhaul links.
Paragraph 25. A method according to any of Paragraphs 1 to 24, comprising
   transmitting, to one of the infrastructure equipment via a backhaul link between that infrastructure equipment and the repeater, an indication of a capability of the repeater.
Paragraph 26. A method according to Paragraph 25, wherein the indication of the capability of the repeater comprises an indication of whether the repeater is able to transmit signals to and/or receive signals from a first infrastructure equipment via a first backhaul link and simultaneously transmit signals to and/or receive signals from a second infrastructure equipment via a second backhaul link.
Paragraph 27. A method according to Paragraph 25 or Paragraph 26, wherein the indication of the capability of the repeater comprises an indication of whether the repeater is an active repeater or a passive repeater.
Paragraph 28. A method according to any of Paragraphs 25 to 27, wherein the indication of the capability of the repeater comprises an indication of a range over which the repeater is able to transmit and/or receive signals.
Paragraph 29. A method according to any of Paragraphs 25 to 28, wherein the indication of the capability of the repeater comprises an indication of whether the repeater is able, within each of the specified time periods, to receive SCI at only one occasion or at more than one occasion.
Paragraph 30. A method according to any of Paragraphs 25 to 29, wherein the indication of the capability of the repeater comprises an indication of a beam configuration of the repeater on one or more backhaul links and/or one or more access links.
Paragraph 31. A method according to any of Paragraphs 1 to 30, wherein signals are transmitted and/or received by the repeater within a first bandwidth part, BWP, and with a first subcarrier spacing, SCS, via the control link and within a second BWP and with a second SCS via a backhaul link that is associated with the control link, wherein the first BWP is different to the second BWP and the first SCS is different to the second SCS.
Paragraph 32. A method according to any of Paragraphs 1 to 31, wherein signals are transmitted and/or received by the repeater within a first bandwidth part, BWP, and with a first subcarrier spacing, SCS, via the control link and within a second BWP and with the first SCS via a backhaul link that is associated with the control link, wherein the first BWP is different to the second BWP.
Paragraph 33. A method according to Paragraph 31 or Paragraph 32, wherein signals are transmitted to and/or received from one of the communications devices by the repeater via an access link between the repeater and that communications device within the first BWP and with the first SCS.
Paragraph 34. A method according to any of Paragraphs 1 to 33, comprising
   receiving downlink signals via a backhaul link from one of the infrastructure equipment using one or more backhaul beams for which backhaul beam information is indicated by one or more of the received pieces of SCI, and forwarding the received downlink signals via an access link to one of the communications devices using one or more access beams, and/or
   receiving uplink signals via the access link from the communications device using one or more access beams, and forwarding the received uplink signals via the backhaul link to the infrastructure equipment using one or more backhaul beams for which backhaul beam information is indicated by one or more of the received pieces of SCI.
Paragraph 35. A method according to Paragraph 34, wherein signals are transmitted and/or received by the repeater in one or more of a plurality of frequency sets, each of the plurality of frequency sets being either only for the transmission or reception of downlink signals or only for the transmission or reception of uplink signals.
Paragraph 36. A method according to Paragraph 35, wherein the downlink signals are received from the infrastructure equipment within a first of the frequency sets which is only for the transmission or reception of downlink signals, and the downlink signals are forwarded to the communications device using the first frequency set.
Paragraph 37. A method according to Paragraph 35 or Paragraph 36, wherein the uplink signals are received from the communications device within a second of the frequency sets which is only for the transmission or reception of uplink signals, and the uplink signals are forwarded to the infrastructure equipment using the second frequency set.
Paragraph 38. A method according to any of Paragraphs 34 to 37, wherein the one or more of the received pieces of SCI which indicate the backhaul beam information for receiving the downlink signals via the backhaul link from the infrastructure equipment are downlink side control information, DL-SCI, and wherein the one or more of the received pieces of SCI which indicate the backhaul beam information for forwarding the uplink signals via the backhaul link to the infrastructure equipment are uplink side control information, UL-SCI.
Paragraph 39. A method according to Paragraph 38, wherein DL-SCI and UL-SCI are received separately each as one or more of the received pieces of SCI.
Paragraph 40. A method according to Paragraph 38 or Paragraph 39, wherein one or more of the received pieces of SCI comprises both of DL-SCI and UL-SCI.
Paragraph 41. A method according to any of Paragraphs 34 to 40, wherein a single backhaul beam is mapped to a single access beam.
Paragraph 42. A method according to any of Paragraphs 34 to 41, wherein a plurality of the backhaul beams are mapped to a single access beam.
Paragraph 43. A method according to any of Paragraphs 34 to 42, wherein a single backhaul beam is mapped to a plurality of the access beams.
Paragraph 44. A method according to any of Paragraphs 34 to 43, wherein each of a plurality of the backhaul beams are each mapped to one a plurality of the access beams.
Paragraph 45. A method according to any of Paragraphs 1 to 44, comprising
   receiving uplink signals via the access link from the communications device using all of one or more possible access beams, and forwarding the received uplink signals via the backhaul link to the infrastructure equipment using one or more backhaul beams which correspond to the one or more access beams used to receive the uplink signals from the communications device.
Paragraph 46. A repeater configured to transmit signals to and/or receive signals from one or more infrastructure equipment forming part of a wireless communications network and to transmit signals to and/or receive signals from one or more communications device, the repeater being configured
   to receive from each of the one or more infrastructure equipment, via a control link between that infrastructure equipment and the repeater, one or more pieces of side control information, SCI, wherein each SCI is associated with a backhaul link between one of the infrastructure equipment and the repeater, and wherein each SCI is associated with one of a plurality of specified time periods during which that SCI is received, and
   wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
      an identifier of each of the one or more beams,
      an indication of a duration over which signals are to be transmitted or received via each of the one or more beams, and
      an indication of a type of each of the one or more beams.
Paragraph 47. Circuitry for a repeater configured to transmit signals to and/or receive signals from one or more infrastructure equipment forming part of a wireless communications network and to transmit signals to and/or receive signals from one or more communications device, the repeater being configured
   to receive from each of the one or more infrastructure equipment, via a control link between that infrastructure equipment and the repeater, one or more pieces of side control information, SCI, wherein each SCI is associated with a backhaul link between one of the infrastructure equipment and the repeater, and wherein each SCI is associated with one of a plurality of specified time periods during which that SCI is received, and
   wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
      an identifier of each of the one or more beams,
      an indication of a duration over which signals are to be transmitted or received via each of the one or more beams, and
      an indication of a type of each of the one or more beams.
Paragraph 48. A method of operating a first infrastructure equipment configured to transmit signals to and/or receive signals from a repeater, the first infrastructure equipment being one of a plurality of infrastructure equipment forming part of a wireless communications network, the method comprising
   transmitting to the repeater, via a first control link between the first infrastructure equipment and the repeater, one or more pieces of side control information, SCI, wherein each SCI is associated with a backhaul link between one of the plurality of infrastructure equipment and the repeater, and wherein each SCI is associated with one of a plurality of specified time periods during which that SCI is transmitted, and
   wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
      an identifier of each of the one or more beams,
      an indication of a duration over which signals are to be transmitted or received via each of the one or more beams, and
      an indication of a type of each of the one or more beams.
Paragraph 49. A method according to Paragraph 48, wherein the indication of the duration over which signals are to be transmitted or received via each of the one or more beams comprises an indicated starting symbol in the specified time period and an indicated ending symbol in the specified time period.
Paragraph 50. A method according to Paragraph 48 or Paragraph 49, wherein the indication of the duration over which signals are to be transmitted or received via each of the one or more beams comprises an indicated starting symbol in the specified time period and an indicated length in symbols in the specified time period.
Paragraph 51. A method according to any of Paragraphs 48 to 50, wherein the indication of the duration over which signals are to be transmitted or received via each of the one or more beams comprises an indicated bitmap of all symbols in the specified time period.
Paragraph 52. A method according to any of Paragraphs 48 to 51, wherein the indication of the type of each of the one or more beams comprises an indicated frequency band of that beam.
Paragraph 53. A method according to any of Paragraphs 48 to 52, wherein the indication of the type of each of the one or more beams comprises an indicated beamwidth of that beam.
Paragraph 54. A method according to Paragraph 53, wherein the indicated beamwidth is indicated from one of a plurality of predefined beamwidths.
Paragraph 55. A method according to any of Paragraphs 48 to 54, wherein the indication of the type of each of the one or more beams comprises an indication of a type of signal used to form that beam.
Paragraph 56. A method according to any of Paragraphs 48 to 55, wherein the indication of the type of each of the one or more beams in backhaul beam information is an explicit indication.
Paragraph 57. A method according to any of Paragraphs 48 to 56, wherein the indication of the type of each of the one or more beams in backhaul beam information is implicitly indicated by the identifier of that beam indicated in the backhaul beam information.
Paragraph 58. A method according to any of Paragraphs 48 to 57, wherein, within each of the specified time periods, there are at least two occasions at which one or more of the transmitted pieces of SCI associated with that specified time period are transmitted, and wherein each SCI associated with that specified time period indicates the backhaul beam information for only a subset of the one or more beams to be used for the transmission of signals over the backhaul link with which that SCI is associated and during that specified time period.
Paragraph 59. A method according to any of Paragraphs 48 to 58, wherein, within each of the specified time periods, all of the transmitted pieces of SCI are transmitted at the same time, and wherein each SCI associated with that specified time period indicates the backhaul beam information for all of the one or more beams to be used for the transmission of signals over the backhaul link with which that SCI is associated and during that specified time period.
Paragraph 60. A method according to any of Paragraphs 48 to 59, wherein all of the transmitted pieces of SCI are transmitted via the first control link from the first infrastructure equipment, and wherein one or more of the transmitted pieces of SCI are associated with a first backhaul link between the first infrastructure equipment and the repeater, and the other transmitted pieces of SCI are associated with a second backhaul link between a second infrastructure equipment and the repeater.
Paragraph 61. A method according to any of Paragraphs 48 to 60, wherein all of the transmitted pieces of SCI are transmitted via the first control link from the first infrastructure equipment, and wherein the transmitted pieces of SCI are each associated with both of a first backhaul link between the first infrastructure equipment and the repeater and a second backhaul link between a second infrastructure equipment and the repeater.
Paragraph 62. A method according to Paragraph 61, wherein each of the transmitted pieces of SCI indicates the same durations for the beams to be used for the transmission of signals over the first backhaul link as for the beams to be used for the transmission of signals over the second backhaul link, and wherein each of the transmitted pieces of SCI indicates different identifiers and types for the beams to be used for the transmission of signals over the first backhaul link than for the beams to be used for the transmission of signals over the second backhaul link.
Paragraph 63. A method according to Paragraph 61 or Paragraph 62, wherein each of the transmitted pieces of SCI indicates the same backhaul beam information for the beams to be used for the transmission of signals over the first backhaul link as for the beams to be used for the transmission of signals over the second backhaul link.
Paragraph 64. A method according to ay of Paragraphs 48 to 63, wherein one or more of the transmitted pieces of SCI are associated with a first backhaul link between the first infrastructure equipment and the repeater, and wherein the one or more of the transmitted pieces of SCI are transmitted via the first control link between the first infrastructure equipment and the repeater, the first control link being associated with the first backhaul link.
Paragraph 65. A method according to any of Paragraphs 48 to 64, wherein the one or more pieces of SCI are transmitted via dynamic signalling.
Paragraph 66. A method according to Paragraph 65, wherein the dynamic signalling of the one or more pieces of SCI comprises the one or more pieces of SCI being transmitted via downlink control information, DCI.
Paragraph 67. A method according to Paragraph 65 or Paragraph 66, wherein the dynamic signalling of the one or more pieces of SCI comprises the one or more pieces of SCI being transmitted via one or more downlink data channels.
Paragraph 68. A method according to any of Paragraphs 48 to 67, wherein the one or more pieces of SCI are transmitted via semi-static signalling.
Paragraph 69. A method according to any of Paragraphs 48 to 68, wherein a type of signalling via which each of the one or more pieces of SCI are transmitted depends on the type of the one or more beams to be used for the transmission and/or reception of signals over the backhaul link with which that SCI is associated and during the specified time period with which that SCI is associated, and wherein the type of signalling is one of semi-static signalling, static signalling, and dynamic signalling.
Paragraph 70. A method according to any of Paragraphs 48 to 69, comprising
   receiving, from the repeater via a backhaul link between the first infrastructure equipment and the repeater, an indication of a capability of the repeater.
Paragraph 71. A method according to Paragraph 70, wherein the indication of the capability of the repeater comprises an indication of whether the repeater is able to transmit signals to and/or receive signals from the first infrastructure equipment via a first backhaul link and simultaneously transmit signals to and/or receive signals from a second infrastructure equipment via a second backhaul link.
Paragraph 72. A method according to Paragraph 70 or Paragraph 71, wherein the indication of the capability of the repeater comprises an indication of whether the repeater is an active repeater or a passive repeater.
Paragraph 73. A method according to any of Paragraphs 70 to 72, wherein the indication of the capability of the repeater comprises an indication of a range over which the repeater is able to transmit and/or receive signals.
Paragraph 74. A method according to any of Paragraphs 70 to 73, wherein the indication of the capability of the repeater comprises an indication of whether the repeater is able, within each of the specified time periods, to receive SCI at only one occasion or at more than one occasion.
Paragraph 75. A method according to any of Paragraphs 70 to 74, wherein the indication of the capability of the repeater comprises an indication of a beam configuration of the repeater on one or more backhaul links and/or one or more access links.
Paragraph 76. A first infrastructure equipment forming part of a wireless communications network, the first infrastructure equipment being one of a plurality of infrastructure equipment forming the wireless communications network, the first infrastructure equipment comprising
   transceiver circuitry configured to transmit signals to and/or to receive signals from a repeater, and
   controller circuitry configured in combination with the transceiver circuitry
   to transmit, to the repeater, via a first control link between the first infrastructure equipment and the repeater, one or more pieces of side control information, SCI, wherein each SCI is associated with a backhaul link between one of the plurality of infrastructure equipment and the repeater, and wherein each SCI is associated with one of a plurality of specified time periods during which that SCI is transmitted, and
   wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
      an identifier of each of the one or more beams,
      an indication of a duration over which signals are to be transmitted or received via each of the one or more beams, and
      an indication of a type of each of the one or more beams.
Paragraph 77. Circuitry for a first infrastructure equipment forming part of a wireless communications network, the first infrastructure equipment being one of a plurality of infrastructure equipment forming the wireless communications network, the circuitry comprising
   transceiver circuitry configured to transmit signals to and/or to receive signals from a repeater, and
   controller circuitry configured in combination with the transceiver circuitry
   to transmit, to the repeater, via a first control link between the first infrastructure equipment and the repeater, one or more pieces of side control information, SCI, wherein each SCI is associated with a backhaul link between one of the plurality of infrastructure equipment and the repeater, and wherein each SCI is associated with one of a plurality of specified time periods during which that SCI is transmitted, and
   wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
      an identifier of each of the one or more beams,
      an indication of a duration over which signals are to be transmitted or received via each of the one or more beams, and
      an indication of a type of each of the one or more beams.
Paragraph 78. A wireless communications system comprising an infrastructure equipment according to Paragraph 76 and a repeater according to Paragraph 46.
Paragraph 79. A wireless communications system according to Paragraph 78, further comprising at least one communications device configured to communicate with the repeater via an access link.
Paragraph 80. A computer program comprising instructions which, when loaded onto a computer, cause the computer to perform a method according to any of Paragraphs 1 to 45 or any of Paragraphs 48 to 75.
Paragraph 81. A non-transitory computer-readable storage medium storing a computer program according to Paragraph 80.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

Holma H. and Toskala A, “LTE for UMTS OFDMA and SC-FDMA based radio access”, John Wiley and Sons, 2009.
“New SI, Study on NR Network-controlled Repeaters”, ZTE Corporation, 3GPP document RP-213700, December 2021.
3GPP TR 38.867, “3^{rd} Generation Partnership Project; Technical Specification Group Radio Access Network; Study on NR network-controlled repeaters; (Release 18)”, V18.0.0, 3GPP, September 2022.
3GPP TR 38.300, “3^{rd} Generation Partnership Project; Technical Specification Group Radio Access Network; NR; NR and NG-RAN Overall Description; Stage 2 (Release 17)”, V17.1.0, 3GPP, June 2022.

1. A method of operating a repeater configured to transmit signals to and/or receive signals from one or more infrastructure equipment forming part of a wireless communications network and to transmit signals to and/or receive signals from one or more communications devices, the method comprising
receiving from each of the one or more infrastructure equipment, via a control link between that infrastructure equipment and the repeater, one or more pieces of side control information, SCI, wherein each SCI is associated with a backhaul link between one of the infrastructure equipment and the repeater, and wherein each SCI is associated with one of a plurality of specified time periods during which that SCI is received, and
wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
an identifier of each of the one or more beams,
an indication of a duration over which signals are to be transmitted or received via each of the one or more beams, and
an indication of a type of each of the one or more beams.

2. A method according to claim 1, wherein the indication of the duration over which signals are to be transmitted or received via each of the one or more beams comprises an indicated starting symbol in the specified time period and an indicated ending symbol in the specified time period.

3. A method according to claim 1, wherein the indication of the duration over which signals are to be transmitted or received via each of the one or more beams comprises an indicated starting symbol in the specified time period and an indicated length in symbols in the specified time period.

4. A method according to claim 1, wherein the indication of the duration over which signals are to be transmitted or received via each of the one or more beams comprises an indicated bitmap of all symbols in the specified time period.

5. A method according to claim 1, wherein the indication of the type of each of the one or more beams comprises an indicated frequency band of that beam.

6. A method according to claim 1, wherein the indication of the type of each of the one or more beams comprises an indicated beamwidth of that beam.

7. A method according to claim 6, wherein the indicated beamwidth is indicated from one of a plurality of predefined beamwidths.

8. A method according to claim 1, wherein the indication of the type of each of the one or more beams comprises an indication of a type of signal used to form that beam.

9. A method according to claim 1, wherein the indication of the type of each of the one or more beams in backhaul beam information is an explicit indication.

10. A method according to claim 1, wherein the indication of the type of each of the one or more beams in backhaul beam information is implicitly indicated by the identifier of that beam indicated in the backhaul beam information.

11. A method according to claim 1, wherein, within each of the specified time periods, there are at least two occasions at which one or more of the received pieces of SCI associated with that specified time period are received, and wherein each SCI associated with that specified time period indicates the backhaul beam information for only a subset of the one or more beams to be used for the transmission of signals over the backhaul link with which that SCI is associated and during that specified time period.

12. A method according to claim 1, wherein, within each of the specified time periods, all of the received pieces of SCI are received at the same time, and wherein each SCI associated with that specified time period indicates the backhaul beam information for all of the one or more beams to be used for the transmission of signals over the backhaul link with which that SCI is associated and during that specified time period.

13. A method according to claim 1, wherein all of the received pieces of SCI are received via a first control link from a first infrastructure equipment, and wherein one or more of the received pieces of SCI are associated with a first backhaul link between the first infrastructure equipment and the repeater, and the other received pieces of SCI are associated with a second backhaul link between a second infrastructure equipment and the repeater.

14. A method according to claim 1, wherein all of the received pieces of SCI are received via a first control link from a first infrastructure equipment, and wherein the received pieces of SCI are each associated with both of a first backhaul link between the first infrastructure equipment and the repeater and a second backhaul link between a second infrastructure equipment and the repeater.

15. A method according to claim 14, wherein each of the received pieces of SCI indicates the same durations for the beams to be used for the transmission of signals over the first backhaul link as for the beams to be used for the transmission of signals over the second backhaul link, and wherein each of the received pieces of SCI indicates different identifiers and types for the beams to be used for the transmission of signals over the first backhaul link than for the beams to be used for the transmission of signals over the second backhaul link.

16. A method according to claim 14, wherein each of the received pieces of SCI indicates the same backhaul beam information for the beams to be used for the transmission of signals over the first backhaul link as for the beams to be used for the transmission of signals over the second backhaul link.

17. A method according to claim 1, wherein one or more of the received pieces of SCI are associated with a first backhaul link between the first infrastructure equipment and the repeater, and wherein the one or more of the received pieces of SCI are received via a first control link between the first infrastructure equipment and the repeater, the first control link being associated with the first backhaul link.

18. A method according to claim 1, wherein the one or more pieces of SCI are received via dynamic signalling.

19.-45. (canceled)

46. A repeater configured to transmit signals to and/or receive signals from one or more infrastructure equipment forming part of a wireless communications network and to transmit signals to and/or receive signals from one or more communications device, the repeater being configured
to receive from each of the one or more infrastructure equipment, via a control link between that infrastructure equipment and the repeater, one or more pieces of side control information, SCI, wherein each SCI is associated with a backhaul link between one of the infrastructure equipment and the repeater, and wherein each SCI is associated with one of a plurality of specified time periods during which that SCI is received, and
wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
an identifier of each of the one or more beams,
an indication of a duration over which signals are to be transmitted or received via each of the one or more beams, and
an indication of a type of each of the one or more beams.

47.-75. (canceled)

76. A first infrastructure equipment forming part of a wireless communications network, the first infrastructure equipment being one of a plurality of infrastructure equipment forming the wireless communications network, the first infrastructure equipment comprising
transceiver circuitry configured to transmit signals to and/or to receive signals from a repeater, and
controller circuitry configured in combination with the transceiver circuitry
to transmit, to the repeater, via a first control link between the first infrastructure equipment and the repeater, one or more pieces of side control information, SCI, wherein each SCI is associated with a backhaul link between one of the plurality of infrastructure equipment and the repeater, and wherein each SCI is associated with one of a plurality of specified time periods during which that SCI is transmitted, and
wherein each SCI indicates backhaul beam information for each of one or more backhaul beams to be used for the transmission and/or reception of signals over the backhaul link with which that SCI is associated and during the specified time period with which that SCI is associated, the backhaul beam information comprising one or more of:
an identifier of each of the one or more beams,
an indication of a duration over which signals are to be transmitted or received via each of the one or more beams, and
an indication of a type of each of the one or more beams.

77.-81. (canceled)
